(19) United States
(12) Patent Application Publication
(10) Pub. No.: US 2024/0158286 A1
(43) Pub. Date: May 16, 2024

(54) SOLAR DARK GREEN GLASS

(71) Applicant: FUYAO GLASS INDUSTRY GROUP CO., LTD., Fuqing,Fujian (CN)

(72) Inventors: Shimeng HE, Fuqing,Fuzhou,Fujian (CN); Guoshu CHEN, Fuqing,Fuzhou,Fujian (CN); Rubin XU, Fuqing,Fuzhou,Fujian (CN); Jianguang GUAN, Fuqing,Fuzhou,Fujian (CN); Qinglin YANG, Fuqing,Fuzhou,Fujian (CN); Suquan YE, Fuqing,Fuzhou,Fujian (CN); Zhaofeng LIAN, Fuqing,Fuzhou,Fujian (CN); Kaifu LIN, Fuqing,Fuzhou,Fujian (CN); Xiangzhi LUO, Fuqing,Fuzhou,Fujian (CN)

(73) Assignee: FUYAO GLASS INDUSTRY GROUP CO., LTD., Fuqing,Fujian (CN)

(21) Appl. No.: 18/279,691

(22) PCT Filed: Mar. 10, 2022
(86) PCT No.: PCT/CN2022/080070

§ 371 Date: Aug. 31, 2023

(30) Foreign Application Priority Data
Mar. 10, 2021 (CN) 202110260465.0

(51) Int. Cl. C03C 4/02; B60J 1/00; C03C 3/087; C03C 4/08; C03C 4/10

(52) U.S. Cl. CPC C03C 4/02; B60J 1/00; C03C 3/087; C03C 4/082; C03C 4/085; C03C 4/10

(57) ABSTRACT

A solar dark green glass and a vehicle are provided. The solar dark green glass includes a glass basic component and a glass tinted component. The solar dark green glass includes a glass basic component and a mass tinted component. The glass tinted component includes, as percentages by weight, 0.8%-2.0% total iron expressed as Fe₂O₃, 0.01%-0.6% TiO₂, 0.001%-2.0% CeO₂, 5 ppm-150 ppm Cr₂O₃, 15 ppm-60 ppm Zro₂, 2 ppm-1000 ppm CuO, 5 ppm-50 ppm SrO, 80 ppm-200 ppm BaO, and 5 ppm-120 ppm Co₂O₃. A content of total iron expressed as Fe₂O₃ and a content of TiO₂ total 1.0%-2.0%, and the content of TiO₂ and a content of CeO₂ total 0.2%-2.1%. The solar dark green glass manufactured has a thickness of 1.6 mm-2.1 mm, and solar direct transmittance less than or equal to 65%, infrared transmittance less than or equal to 45%, and ultraviolet transmittance less than or equal to 35%.

### CROSS-REFERENCE TO RELATED APPLICATION(S)

This application is a National Stage of International Application No. PCT/CN2022/080070, filed Mar. 10, 2022, which claims priority to Chinese Patent Application No. 202110260465.0, filed Mar. 10, 2021, the entire disclosures of which are hereby incorporated by reference.

### TECHNICAL FIELD

This disclosure relates to the field of float glass technology, and in particular to a solar dark green glass having lower infrared transmittance and lower ultraviolet transmittance.

### BACKGROUND

Glass products are widely used in industries such as building, vehicle, daily use, medical, chemical, household, electronic, and instrument. With advancement of production technology, requirements for performance and color of the glass products have been continuously increased and satisfied, and glass of different color has been gradually applied to more middle-high-end and special-performance vehicles. The optical change of the glass gives different color and performance to the glass. In an application of vehicle glass, a dark glass product can be used as a side window glass, a rear window glass, a panoramic sunroof, etc. of a vehicle, so as to protect privacy of a space inside the vehicle and achieve a purpose of reducing incidence of infrared rays and ultraviolet rays, such that the inside of the vehicle is more comfortable.

A green glass used in a prior vehicle can also achieve the purpose of reducing the transmission of infrared rays and ultraviolet rays to a certain extent, but the green glass generally has a relatively large thickness, for example, greater than 2.1 mm, and cannot satisfy requirements for having lower infrared transmittance and lower ultraviolet transmittance after being thinned due to requirements for vehicle weight reduction.

### SUMMARY

A solar dark green glass includes a glass basic component and a glass tinted component. The glass tinted component includes, as percentages by weight, 0.8%-2.0% total iron expressed as Fe₂O₃, 0.01%-0.6% titanium dioxide (TiO₂), 0.001%-2.0% cerium oxide (CeO₂), 5 parts per million (ppm)-150 ppm chromium(III) oxide (Cr₂O₃), 15 ppm-60 ppm zirconium dioxide (ZrO₂), 2 ppm-1000 ppm copper(II) oxide (CuO), 5 ppm-50 ppm strontium oxide (SrO), 80 ppm-200 ppm barium oxide (BaO), and 5 ppm-120 ppm cobalt(III) oxide (Co₂O₃). A content of total iron expressed as Fe₂O₃ and a content of TiO₂ total 1.0%-2.0%, and the content of TiO₂ and a content of CeO₂ total 0.2%-2.1%. The solar dark green glass has a thickness of 1.6 mm-2.1 mm, and solar direct transmittance less than or equal to 65%, infrared transmittance less than or equal to 45%, and ultraviolet transmittance less than or equal to 35%.

A vehicle is further provided in the present disclosure. The vehicle includes a vehicle body and a vehicle window. The vehicle window is disposed at the vehicle body. The vehicle window includes a solar dark green glass. The solar dark green glass includes a glass basic component and a glass tinted component. The glass tinted component includes, as percentages by weight, 0.8%-2.0% total iron expressed as Fe₂O₃, 0.01%-0.6% TiO₂, 0.001%-2.0% CeO₂, 5 ppm-150 ppm Cr₂O₃, 15 ppm-60 ppm ZrO₂, 2 ppm-1000 ppm CuO, 5 ppm-50 ppm SrO, 80 ppm-200 ppm BaO, and 5 ppm-120 ppm Co₂O₃. A content of total iron expressed as Fe₂O₃ and a content of TiO₂ total 1.0%-2.0%, and the content of TiO₂ and a content of CeO₂ total 0.2%-2.1%. The solar dark green glass has a thickness of 1.6 mm-2.1 mm, and solar direct transmittance less than or equal to 65%, infrared transmittance less than or equal to 45%, and ultraviolet transmittance less than or equal to 35%.

### BRIEF DESCRIPTION OF THE DRAWINGS

To describe technical solutions in implementations of the present disclosure more clearly, the following describes the accompanying drawings required for describing implementations of the present disclosure.

FIG. 1 is a schematic diagram of a vehicle in an implementation of the present disclosure.

### REFERENCE SIGNS

100-vehicle, 110-vehicle body, 120-vehicle window, 121-solar dark green glass.

### DETAILED DESCRIPTION

To describe the technical content, the purpose, and the effect of the present disclosure in detail, the following describes the technical content with reference to implementations.

The term “implementation” referred to herein means that a particular feature, structure, or characteristic described in conjunction with the implementation may be contained in at least one implementation of the present disclosure. The phrase “implementation” appearing in various places in the specification does not necessarily refer to the same implementation, nor does it refer to an independent or alternative implementation that is mutually exclusive with other implementations. It is expressly and implicitly understood by those skilled in the art that implementations described herein may be combined with other implementations.

A solar dark green glass is provided in the present disclosure. The solar dark green glass includes a glass basic component and a glass tinted component. The glass basic component includes, as percentages by weight, 63%-73% silicon dioxide (SiO₂), 10%-18% sodium oxide (Na₂O), 4%-14% calcium oxide (CaO), 2%-6% magnesium oxide (MgO), 0.1%-2% aluminium oxide (Al₂O₃), and 0.01%-1% potassium oxide (K₂O). A weight percentage of Na₂O may be, but is not limited to, 10%, 11%, 12%, 13%, 14%, 15%, 16%, 17%, or 18%. In the glass, Na₂O can reduce high-temperature viscosity of the glass, reduce a change threshold of a structure of the tinted component, and increase a coefficient of thermal expansion (CTE) of the glass. If the content of Na₂O is too low, a melting ability of the glass raw material may be reduced; and if the content of Na₂O is too high, weather resistance of the glass may be reduced.

A weight percentage of K₂O may be, but is not limited to, 0.01%, 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, or 1%. K₂O and Na₂O belong to alkali metal oxides, and a function of K₂O is also similar to a function of Na₂O. If the sum of the content of Na₂O and the content of K₂O is too low, the melting ability of the glass raw material may be reduced; and if the sum of the content of Na₂O and the content of K₂O is too high, chemical stability of the glass is reduced, the weather resistance of the glass is reduced, and production costs of the glass are increased.

A weight percentage of CaO may be, but is not limited to, 4%, 5%, 6%, 7%, 8%, 9%, 10%, 11%, 12%, 13%, or 14%. CaO can improve stability of the glass and devitrification resistance of the glass, reduce the high-temperature viscosity of the glass. If the content of CaO is too high, the glass may be devitrified, and the stability of the glass is reduced; and if the content of CaO is too low, the melting ability of the raw glass material may be reduced.

A weight percentage of MgO may be, but is not limited to, 2%, 2.5%, 3%, 3.5%, 4%, 4.5%, 5%, 5.5%, and 6%. MgO can improve the chemical stability of the glass and facilitate the melting ability of the glass raw material. If the content of MgO is too high, the devitrification resistance of the glass is reduced, such that the glass may be devitrified, and the stability of glass is reduced; and if the content of MgO is too low, the melting ability of the glass raw material may be reduced.

A weight percentage of Al₂O₃ may be, but is not limited to, 0.1%, 0.3%, 0.5%, 0.7%, 0.9%, 1.1%, 1.3%, 1.5%, 1.7%, 1.9%, or 2%. In the glass, Al₂O₃ can also improve the chemical stability of the glass. If the content of Al₂O₃ is too low, the weather resistance of the glass is reduced; and if the content of Al₂O₃ is too high, the glass raw material will be difficult to melt.

SiO₂ is a main component of the glass, and has relatively stable chemical properties, so that the glass has good weather resistance. In the present disclosure, a weight percentage of SiO₂ may be, but is not limited to, 63%, 64%, 65%, 66%, 67%, 68%, 69%, 70%, 71%, 72%, or 73%. In the present disclosure, if the content of SiO₂ is too low, the weather resistance of the glass is reduced, and the glass raw material is difficult to melt.

The glass tinted component includes, as percentages by weight, 0.8%-2.0% total iron expressed as Fe₂O₃, 0.01%-0.6% titanium dioxide (TiO₂), 0.001%-2.0% cerium oxide (CeO₂), 5 parts per million (ppm)-150 ppm chromium(III) oxide (Cr₂O₃), 15 ppm-60 ppm zirconium dioxide (ZrO₂), 2 ppm-1000 ppm copper(II) oxide (CuO), 5 ppm-50 ppm strontium oxide (SrO), 80 ppm-200 ppm barium oxide (BaO), and 5 ppm-120 ppm cobalt(III) oxide (Co₂O₃).

A weight percentage of total iron expressed as Fe₂O₃ may be, but is not limited to, 0.8%, 0.9%, 1.0%, 1.1%, 1.2%, 1.3%, 1.4%, 1.5%, 1.6%, 1.7%, 1.8%, 1.9%, or 2.0%. Total iron expressed as Fe₂O₃ is used as a main tinting agent (i.e., colorant) for tinting green of the glass and adjusting transmittance of the glass. Total iron expressed as Fe₂O₃ exists in the form of ferrous iron (Fe²⁺) and ferric iron (Fe³⁺), etc., the ferrous iron (Fe²⁺) can be used as an infrared absorption component, and the ferric iron (Fe³⁺) can be used as an ultraviolet absorption component. If the content of total iron expressed as Fe₂O₃ is too low, the infrared absorption performance and the ultraviolet absorption performance may be reduced. If the content of total iron expressed as Fe₂O₃ is too high, the visible light transmittance of the glass is reduced. In the present disclosure, total iron expressed as Fe₂O₃ refers to all iron oxides present in the glass, including both ferrous iron (i.e., FeO) and ferric iron (i.e., Fe₂O₃), which is an universal expression method in the art, and does not mean that all iron oxides in the glass are iron(III) oxide Fe₂O₃.

In the present disclosure, a ratio of a weight content of ferrous iron expressed in the form of FeO to a weight content of total iron expressed in the form of Fe₂O₃ is defined as a redox ratio, which is used for adjusting the ultraviolet transmittance and the infrared transmittance. The redox ratio of the solar dark green glass is 0.1-0.5, and specifically, such as, 0.17, 0.19, 0.23, 0.24, 0.25, 0.31, 0.37, 0.46, 0.49, etc. If the redox ratio is too low, it indicates that the content of ferrous iron in the glass is too low, such that the infrared absorption ability of the glass is weak; and if the redox ratio is too high, it indicates that the content of ferrous iron in the glass is too high, such that the melting difficulty of the glass raw material is increased and the glass is bluish.

A weight percentage of TiO₂ may be, but is not limited to, 0.01%, 0.05%, 0.1%, 0.15%, 0.2%, 0.25%, 0.3%, 0.35%, 0.4%, 0.45%, 0.5%, 0.55%, or 0.6%. TiO₂ can enable the glass to have ultraviolet blocking performance and serve as a yellow tinting agent. Optionally, the content of total iron expressed as Fe₂O₃ and the content of TiO₂ are 1.0%-2.0%, and the content of total iron expressed as Fe₂O₃ and the content of TiO₂ may be, but are not limited to, 1.0%, 1.1%, 1.2%, 1.3%, 1.4%, 1.5%, 1.6%, 1.7%, 1.8%, 1.9%, or 2.0%. If the content of total iron expressed as Fe₂O₃ and the content of TiO₂ are too low, the beneficial effect on the glass is not obvious; and if the content of total iron expressed as Fe₂O₃ and the content of TiO₂ are too high, the devitrification resistance of the glass is reduced.

A weight percentage of CeO₂ may be, but is not limited to, 0.001%, 0.005%, 0.01%, 0.015%, 0.02%, 0.03%, 0.04%, 0.05%, 0.06%, 0.1%, 0.15%, 0.2%, 0.25%, 0.3%, 0.35%, 0.4%, 0.45%, 0.5%, 1.0%, 1.5%, or 2.0%. CeO₂ can enable the glass to have the ultraviolet blocking performance and serve as a yellow tinting. If the content of CeO₂ is too low, the beneficial effect on the glass is not obvious; and if the content of CeO₂ is too high, the production costs of the glass are greatly increased, the production efficiency is reduced, and the glass is made yellowish. Optionally, the content of titanium oxide TiO₂ and the content of CeO₂ is 0.2%-2.1%. In the present disclosure, the content of TiO₂ and the content of CeO₂ may be, but are not limited to, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, or 2.0%. If the content of TiO₂ and the content of CeO₂ are too high, the devitrification resistance of the glass is reduced; and if the content of TiO₂ and the content of CeO₂ are too low, the beneficial effect on the glass is not obvious.

Optionally, when the content of TiO₂ is greater than or equal to 0.2%, from consideration of manufacturing convenience and economy, a ratio of the content of TiO₂ to the content of CeO₂ is greater than or equal to 20, such as, 20, 21, 22, 23, 24, 25, 26, 27, 28, 29, 30, 40, etc., and more preferably, 20 to 28. When the content of TiO₂ is greater than or equal to 0.2%, the content of TiO₂ is greater than the content of CeO₂. In this case, if the ratio of the content of TiO₂ to the content of CeO₂ is less than 20, ultraviolet blocking performance of the glass is reduced.

Optionally, when the content of TiO₂ is less than 0.1%, from the consideration of manufacturing convenience and economy, a ratio of the content of CeO₂ to the content of TiO₂ is 5-40, such as, 5, 6, 7, 8, 10, 15, 20, 25, 30, 35, 40, etc. When the content of TiO₂ is less than 0.1%, the content of TiO₂ is less than the content of CeO₂. If the ratio of the content of CeO₂ to the content of TiO₂ is less than 5 at this time, the ultraviolet blocking performance of the glass cannot satisfy the design requirements; and if the ratio of the content of CeO₂ to the content of TiO₂ is greater than 40 at this time, the glass can be easily devitrified and even ceramic.

A weight percentage of Cr₂O₃ may be, but is not limited to, 5 ppm, 10 ppm, 20 ppm, 30 ppm, 40 ppm, 50 ppm, 60 ppm, 70 ppm, 80 ppm, 90 ppm, 100 ppm, 110 ppm, 120 ppm, 130 ppm, 140 ppm, or 150 ppm. Cr₂O₃ can enable the glass to have the ultraviolet blocking performance and serve as a yellow-green and emerald tinting agent.

A weight percentage of CuO may be, but is not limited to, 2 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm, or 1000 ppm. CuO can serve as a cyan tinting agent. Optionally, the content of CuO is 100 ppm-800 ppm. From the consideration of manufacturing convenience and economy, optionally, a ratio of the content of CuO to the content of Cr₂O₃ content is 5 to 60, such as, 5, 10, 15, 20, 25, 30, 35, 40, 45, 50, 55, 60, etc.

A weight percentage of Co₂O₃ may be, but is not limited to, 5 ppm, 10 ppm, 20 ppm, 30 ppm, 40 ppm, 50 ppm, 60 ppm, 70 ppm, 80 ppm, 90 ppm, 100 ppm, 110 ppm, or 120 ppm. Co₂O₃ is used as a light blue tinting agent for the glass, which can be used for adjusting the color of the glass, and Co₂O₃ itself also has a certain infrared absorption function. If the content of Co₂O₃ is too low, the beneficial effect on the glass is not obvious; and if the content of Co₂O₃ is too high, the devitrification resistance of the glass is weak. Optionally, the content of Co₂O₃ is 8 ppm-110 ppm.

A weight percentage of ZrO₂ may be, but is not limited to, 15 ppm, 20 ppm, 25 ppm, 30 ppm, 35 ppm, 40 ppm, 45 ppm, 50 ppm, 55 ppm, or 60 ppm. A weight percentage of BaO may be, but is not limited to, 80 ppm, 90 ppm, 100 ppm, 110 ppm, 120 ppm, 130 ppm, 140 ppm, 150 ppm, 160 ppm, 170 ppm, 180 ppm, 190 ppm, or 200 ppm. A weight percentage of SrO may be, but is not limited to, 5 ppm, 10 ppm, 15 ppm, 20 ppm, 25 ppm, 30 ppm, 35 ppm, 40 ppm, 45 ppm, or 50 ppm. A proper content of ZrO₂, a proper content of BaO, and a proper content of SrO can improve the chemical stability of the glass and improve hardness of the glass. If the content of ZrO₂, the content of BaO, and the content of SrO that are adopted are too high, an ability of the glass to fix the tinted component is reduced; and if the content of ZrO₂, the content of BaO, and the content of SrO are too low, the beneficial effect on the glass is not obvious. From the consideration of manufacturing convenience and economy, optionally, a ratio of the content of BaO to the content of SrO is 5-40, such as, 5.4, 6, 7, 8, 8.2, 8.3, 8.7, 9, 9.1, 9.6, 9.9, 10, 11, 12, 13, 14.9, etc. Optionally, the ratio of the content of BaO to the content of ZrO₂ is 2-8, such as, 2, 2.9, 3, 3.4, 3.5, 3.8, 3.9, 4.0, 4.2, 5, 6, 7, 8, etc. Optionally, the content of ZrO₂ may be 30 ppm-40 ppm.

From the consideration of manufacturing convenience and economy, the solar dark green glass in the present disclosure is free of nickel(II) oxide (NiO). Generally, NiO reduces the visible light transmittance of the glass, but does not reduce the infrared transmittance and the ultraviolet transmittance. In addition, NiO is easy to make glass be brownish, and may also react with molten tin in a float bath, so that the glass with a desired hue cannot be obtained.

In the present disclosure, by controlling the glass tinted component in a strict proportion, the solar dark green glass with a thickness of 1.6 mm-2.1 mm can be obtained. The thickness of the solar dark green glass may be, but is not limited to, 1.6 mm, 1.7 mm, 1.8 mm, 1.9 mm, 2.0 mm, or 2.1 mm. The solar dark green glass has the solar direct transmittance less than or equal to 65%, the infrared transmittance less than or equal to 45%, and the ultraviolet transmittance less than or equal to 35%. In some implementations, the solar direct transmittance of the solar dark green glass is less than or equal to 50%, and the infrared transmittance of the solar dark green glass is less than or equal to 30%. The solar direct transmittance may be, but is not limited to, 41%, 43%, 45%, 47%, 49%, 50%, 51%, 52%, 53%, 54%, 55%, 56%, 57%, 58%, 59%, 60%, 61%, 62%, 63%, 64%, or 65%. The infrared transmittance may be, but is not limited to, 21%, 23%, 25%, 27%, 29%, 30%, 31%, 32%, 33%, 34%, 35%, 36%, 37%, 38%, 39%, 40%, 41%, 42%, 43%, 44%, or 45%. The ultraviolet transmittance may be, but is not limited to, 21%, 22%, 23%, 24%, 25%, 26%, 27%, 28%, 29%, 30%, 31%, 32%, 33%, 34%, or 35%. In some implementations, the visible light transmittance of the solar dark green glass greater than or equal to 70%. The visible light transmittance may be, but is not limited to, 70%, 71%, 72%, 73%, 74%, 75%, 76%, 77%, 78%, 79%, or 80%. In the present disclosure, the solar direct transmittance, the infrared transmittance, and the ultraviolet transmittance of the glass can be reduced while the thickness of the glass is thinned.

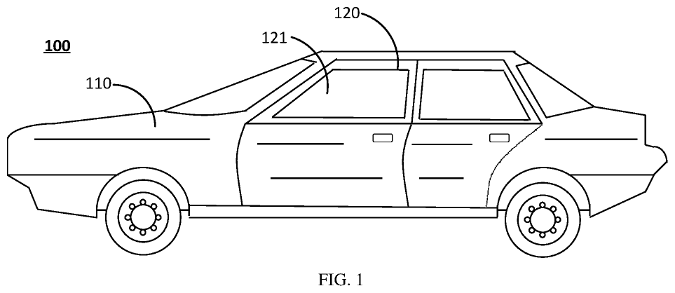

As shown in FIG. 1, a vehicle 100 is further provided in the present disclosure. The vehicle 100 includes a vehicle body 110 and a vehicle window 120. The vehicle window 120 is disposed at the vehicle body 110. The vehicle window 120 includes the solar dark green glass 121 as described in implementations of the present disclosure.

In the vehicle 100 in the present disclosure, by being equipped with the solar dark green glass 121 in the present disclosure, the glass is thinned, thereby satisfying the requirements for vehicle weight reduction, and the vehicle window 120 also satisfies the requirements for lower infrared transmittance and lower ultraviolet transmittance. In an application of the glass of the vehicle window 120, the solar dark green glass 121 in the present disclosure can be used as side window glass, rear window glass, a panoramic sunroof, etc. of the vehicle, so as to protect the privacy of the space inside the vehicle and achieve the purpose of reducing the incidence of infrared rays and ultraviolet rays, etc., such that the inside of the vehicle is more comfortable. The vehicle 100 in the present disclosure may be, but is not limited to, a sedan, a multi-purpose vehicle (MPV), a sport/suburban utility vehicle (SUV), an off-road vehicle (ORV), a pickup, a van, a bus, a truck, and the like.

In the present disclosure, the solar dark green glass may be used as a single sheet of glass, or may be manufactured into laminated glass, hollow glass, vacuum glass, etc., to use.

### Implementations

In the present disclosure, mix raw materials of basic components such as silica sand, soda, dolomite, and limestone, raw materials of tinted components such as iron powder and TiO₂ powder, and a reducing agent, a fining agent, and the like, to prepare a glass raw material; convey the glass raw material into a melting furnace, heat the melting furnace to 1400° C. to 1600° C. (e.g., about 1500° C.) to melt the glass raw material to manufacture a glass melt, then form the glass melt into a glass plate with a predetermined thickness by a glass-plate forming method such as a float method, cut the glass plate up after annealing and cooling the glass plate, obtain glass plates in Implementations 1-11, and perform components analysis on the glass plates. For component analysis results in each implementation, reference can be made to Table 1 and Table 2.

TABLE 1
Results of tinted component analysis of
glass plates in Implementations 1-11

| | Total iron | | | | |
|---|---|---|---|---|---|
| | expressed | | | | |
| | as Fe₂O₃ | Redox | TiO₂ | CeO₂ | Cr₂O₃ |
| | (%) | ratio | (%) | (%) | (PPM) |
| Implementation 1 | 1.23 | 0.24 | 0.29 | 0.011 | 16 |
| Implementation 2 | 1.32 | 0.25 | 0.23 | 0.009 | 18 |
| Implementation 3 | 1.34 | 0.46 | 0.05 | 1.96 | 15 |
| Implementation 4 | 1.39 | 0.19 | 0.05 | 2 | 15 |
| Implementation 5 | 0.91 | 0.23 | 0.23 | 0.011 | 20 |
| Implementation 6 | 0.97 | 0.49 | 0.23 | 0.009 | 10 |
| Implementation 7 | 0.97 | 0.31 | 0.04 | 0.208 | 20 |
| Implementation 8 | 0.93 | 0.37 | 0.22 | 0.008 | 10 |
| Implementation 9 | 0.93 | 0.31 | 0.23 | 0.01 | 20 |
| Implementation 10 | 0.95 | 0.17 | 0.24 | 0.009 | 10 |
| Implementation 11 | 0.93 | 0.19 | 0.23 | 0.01 | 20 |

TABLE 2
Results of tinted component analysis of
glass plates in Implementations 1-11

| | CuO | ZrO₂ | SrO | Co₂O₃ | BaO |
|---|---|---|---|---|---|
| | (PPM) | (PPM) | (PPM) | (PPM) | (PPM) |
| Implementation 1 | 5 | 33 | 19 | 19 | 114 |
| Implementation 2 | 6 | 34 | 21 | 8 | 114 |
| Implementation 3 | 460 | 30 | 8 | 91 | 119 |
| Implementation 4 | 800 | 30 | 9 | 110 | 125 |
| Implementation 5 | 100 | 30 | 12 | 16 | 119 |
| Implementation 6 | 100 | 30 | 13 | 16 | 119 |
| Implementation 7 | 100 | 30 | 13 | 15 | 104 |
| Implementation 8 | 100 | 30 | 12 | 16 | 116 |
| Implementation 9 | 100 | 30 | 13 | 16 | 114 |
| Implementation 10 | 100 | 30 | 14 | 15 | 116 |
| Implementation 11 | 100 | 40 | 14 | 15 | 115 |

The glass plates in Implementations 1-11 are tested by the following method, and results are recorded in Table 3.

In the present disclosure, under International Commission on Illumination (CIE) standard illuminant A, visible light transmittance (Lta) is measured at intervals of 10 nm in a wavelength range of 380 nm-780 nm, ultraviolet transmittance (Tuv) is measured at intervals of 5 nm in a wavelength range of 300 nm-380 nm, infrared transmission (Tnir) is measured at intervals of 50 nm in a wavelength range of 780 nm-2500 nm. Solar direct transmittance (Te) represents a calculated value based on a value of light transmittance measured at intervals of 50 nm in a wavelength range of 300 nm-2500 nm. Lta, Tuv, Tnir, and Te are calculated according to ISO 9050 standard. Color indexes L*, a*, and b* are calculated according to 1976 CIE standard illuminant D65.

TABLE 3
Optical performance of glass plates in Implementations 1-11

| | Lta | Tuv | Te | Tnir | L* | a* | b* |
|---|---|---|---|---|---|---|---|
| Implementation 1 | 77.78 | 27.7 | 56.75 | 39.4 | 91.14 | −5.36 | 2.53 |
| Implementation 2 | 74.74 | 26.43 | 54.29 | 37.39 | 89.77 | −5.49 | 2.33 |
| Implementation 3 | 70.69 | 32.21 | 42.89 | 18.24 | 88.44 | −8.83 | 0 |
| Implementation 4 | 81.02 | 28.98 | 63.29 | 19.36 | 92.39 | −4.09 | 3.19 |
| Implementation 5 | 79.29 | 28.17 | 59.47 | 43.32 | 91.71 | −4.67 | 2.91 |
| Implementation 6 | 68.69 | 30.99 | 40.39 | 15.79 | 87.51 | −9.62 | 0.43 |
| Implementation 7 | 75.57 | 28.67 | 51.33 | 30.64 | 90.26 | −6.35 | 2.32 |
| Implementation 8 | 69.69 | 24.1 | 42.84 | 20.16 | 87.74 | −8.53 | 2.03 |
| Implementation 9 | 73.52 | 24.87 | 48.63 | 27.73 | 89.34 | −6.97 | 2.74 |
| Implementation 10 | 81.89 | 34.08 | 64.26 | 52.01 | 92.82 | −3.93 | 2.98 |
| Implementation 11 | 80.82 | 33.19 | 63.21 | 49.03 | 92.38 | −4.25 | 2.49 |

It can be obtained from the above table that for the solar dark green glass manufactured in the present disclosure, the solar direct transmittance thereof is substantially less than or equal to 65%, or even less than or equal to 50%; the infrared transmittance thereof is less than or equal to 45%, even less than or equal to 30%, or more even less than or equal to 20%; the ultraviolet transmittance thereof is less than or equal to 35%, even less than or equal to 30%, or more even less than or equal to 25%; the visible light transmittance thereof is greater than or equal to 70%, or even greater than or equal to 80%.

It can also be obtained from the above table that the solar dark green glass has a color characterized as follows: when calculated according to 1976 CIE standard illuminant D65, L* ranges from 87.51 to 92.82, a* ranges from −9.62 to −3.93, and b* ranges from 0 to 3.19, where L*, a*, and b* are color indexes of the solar dark green glass. According to the CIELAB color space (which is also referred to as L*a*b*, is a color space defined by CIE in 1976), a color is expressed as three values: L* for perceptual lightness, a* for two unique colors of human vision: red and green, and b* for two unique colors of human vision: blue and yellow. Specifically, L* represents lightness from black to white on a scale of 0 to 100, while a* and b* represent chromaticity with no specific numeric limits. Negative a* corresponds with green, positive a* corresponds with red, negative b* corresponds with blue, and positive b* corresponds with yellow.

The above are merely implementations of the present disclosure, and are not intended to limit the scope of the present disclosure. Any equivalent transformation made by using the description of the present disclosure, or direct or indirect application in the related technical field, shall similarly belong to the protection scope of the present disclosure.

1. A solar dark green glass, comprising a glass basic component and a glass tinted component, wherein the glass tinted component comprises, as percentages by weight:
0.8%-2.0% total iron expressed as Fe₂O₃, 0.01%-0.6% TiO₂, 0.001%-2.0% CeO₂, 5 ppm-150 ppm Cr₂O₃, 15 ppm-60 ppm ZrO₂, 2 ppm-1000 ppm CuO, 5 ppm-50 ppm SrO, 80 ppm-200 ppm BaO, and 5 ppm-120 ppm Co₂O₃; wherein
a content of total iron expressed as Fe₂O₃ and a content of TiO₂ total 1.0%-2.0%, and the content of TiO₂ and a content of CeO₂ total 0.2%-2.1%; and
the solar dark green glass has a thickness of 1.6 mm-2.1 mm, and solar direct transmittance less than or equal to 65%, infrared transmittance less than or equal to 45%, and ultraviolet transmittance less than or equal to 35%.

2. The solar dark green glass of claim 1, wherein a content of CuO is 100 ppm-800 ppm.

3. The solar dark green glass of claim 1, wherein a content of Co₂O₃ is 8 ppm-110 ppm.

4. The solar dark green glass of claim 1, wherein the glass basic component comprises, as percentages by weight, 63%-73% SiO₂, 10%-18% Na₂O, 4%-14% CaO, 2%-6% MgO, 0.1%-2% Al₂O₃, and 0.01%-1% K₂O.

5. The solar dark green glass of claim 1, wherein the solar dark green glass has the solar direct transmittance less than or equal to 50%, and the infrared transmittance less than or equal to 30%.

6. The solar dark green glass of claim 1, wherein the solar dark green glass has visible light transmittance greater than or equal to 70%.

7. The solar dark green glass of claim 1, wherein the solar dark green glass has a redox ratio of 0.1-0.5.

8. The solar dark green glass of claim 1, wherein when the content of TiO₂ is greater than or equal to 0.2%, a ratio of the content of TiO₂ to the content of CeO₂ is greater than or equal to 20.

9. The solar dark green glass of claim 1, wherein when the content of TiO₂ is greater than or equal to 0.2%, a ratio of the content of TiO₂ to the content of CeO₂ is 20-28.

10. The solar dark green glass of claim 1, wherein when the content of TiO₂ is less than 0.1%, a ratio of the content of CeO₂ to the content of TiO₂ is 5-40.

11. The solar dark green glass of claim 1, wherein a ratio of a content of CuO to a content of Cr₂O₃ is 5-60.

12. The solar dark green glass of claim 1, wherein a ratio of a content of BaO to a content of SrO is 5-40.

13. The solar dark green glass of claim 1, wherein a ratio of a content of BaO to a content of ZrO₂ is 2-8.

14. The solar dark green glass of claim 1, wherein a content of ZrO₂ is 30 ppm-40 ppm.

15. The solar dark green glass of claim 1, wherein the solar dark green glass is free of NiO.

16. The solar dark green glass of claim 1, wherein the solar dark green glass is formed by a float-glass-plate forming method.

17. A vehicle, comprising:
a vehicle body; and
a vehicle window disposed at the vehicle body, wherein the vehicle window comprises a solar dark green glass, wherein the solar dark green glass comprises a glass basic component and a glass tinted component, wherein the glass tinted component comprises, as percentages by weight:
0.8%-2.0% total iron expressed as Fe₂O₃, 0.01%-0.6% TiO₂, 0.001%-2.0% CeO₂, 5 ppm-150 ppm Cr₂O₃, 15 ppm-60 ppm ZrO₂, 2 ppm-1000 ppm CuO, 5 ppm-50 ppm SrO, 80 ppm-200 ppm BaO, and 5 ppm-120 ppm Co₂O₃; wherein
a content of total iron expressed as Fe₂O₃ and a content of TiO₂ total 1.0%-2.0%, and the content of TiO₂ and a content of CeO₂ total 0.2%-2.1%; and
the solar dark green glass has a thickness of 1.6 mm-2.1 mm, and solar direct transmittance less than or equal to 65%, infrared transmittance less than or equal to 45%, and ultraviolet transmittance less than or equal to 35%.

18. The solar dark green glass of claim 1, wherein the solar dark green glass has a color characterized as follows: when calculated according to 1976 CIE standard illuminant D65, L* ranges from 87.51 to 92.82, wherein L* is a color index of the solar dark green glass.

19. The solar dark green glass of claim 1, wherein the solar dark green glass has a color characterized as follows: when calculated according to 1976 CIE standard illuminant D65, a* ranges from −9.62 to −3.93, wherein a* is a color index of the solar dark green glass.

20. The solar dark green glass of claim 1, wherein the solar dark green glass has a color characterized as follows: when calculated according to 1976 CIE standard illuminant D65, b* ranges from 0 to 3.19, wherein b* is a color index of the solar dark green glass.
